(19) United States
(12) Patent Application Publication
(10) Pub. No.: US 2009/0101120 A1
(43) Pub. Date: Apr. 23, 2009

(54) FUEL SAVING DEVICE

(76) Inventor: WEN-SHOU LEE, Sanchong City (TW)

Correspondence Address: LEONG C LEI, PMB # 1008, 1867 YGNACIO VALLEY ROAD, WALNUT CREEK, CA, 94598, US

(21) Appl. No.: 11/873,426

(22) Filed: Oct. 17, 2007

(51) Int. Cl. F02M 27/00

(52) U.S. Cl. 123/539

(57) ABSTRACT

A fuel-saving device is disclosed. The device comprises a radiating members unit having a plurality of radiating members arranged in spaced-apart and arranged in an alignment; net body for mounting to each of the spaced-apart radiating members, wherein the fuel-saving device is disposed onto the front end of a catalyst sensor of the exhaust pipe of a vehicle, energy elements of the radiating members convert the oxygen ions to ultra micro particles and the collision of the oxygen particles causes the gas stream molecules to generate naturally turbo which produce propel action and a micro explosion of oxygen particles, the oxygen particles enter the cylinder of the vehicle enhance complete combustion of gasoline.

### BACKGROUND OF THE INVENTION

(a) Technical Field of the Invention

The present invention relates to fuel-saving device, and in particular, to a fuel-saving device which enhances complete combustion of fuel, and reduces pollution of exhaust gas.

(b) Description of the Prior Art

Energy on earth is extensively exhausted and human beings may encounter surviving crisis in the future. Gasoline is exhausted mainly in vehicles, and accordingly, huge investment has been involved in researching device to minimize exhaustion of gasoline. Conventional fuel-saving devices available in the market generally do not effective function and the saving of gasoline or fuel is not noticeable. Accordingly, it is an object of the present invention to provide a fuel-saving device which mitigates the above drawback.

### SUMMARY OF THE INVENTION

The primary purpose of the present invention is to provide a fuel-saving device comprising a radiating members unit having a plurality of radiating members arranged in spaced-apart and arranged in an alignment; net body for mounting to each of the spaced-apart radiating members, wherein the fuel-saving device is disposed onto the front end of a catalyst sensor of the exhaust pipe of a vehicle, energy elements of the radiating members convert the oxygen ions to ultra micro particles and the collision of the oxygen particles causes the gas stream molecules to generate naturally turbo which produce propel action and a micro explosion of oxygen particles, the oxygen particles enter the cylinder of the vehicle enhance complete combustion of gasoline.

Yet still another object of the present invention is to provide a fuel-saving device, wherein the radiating members are ceramic product obtained based on a specific ratio from energy proton of extracted crystal element corresponding to energy element.

Still yet a further object of the present invention is to provide a fuel-saving device, wherein the net body connecting the radiating member units is made from aluminum material to provide heat conduction effect such that the energy element of the radiating members is evenly distributed.

Another object of the present invention is to provide a fuel-saving device, wherein the net body is mounted with a fastening belt, and the two ends of the fastening belt are respectively provided with a locking element and a plurality of positioning holes for the fastening belt wherein the locking element locks the radiating member unit to the front end of the catalyst sensor.

The foregoing object and summary provide only a brief introduction to the present invention. To fully appreciate these and other objects of the present invention as well as the invention itself all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a fuel-saving device of the present invention.

FIG. 2 is a schematic view showing a preferred embodiment in accordance with the present invention.

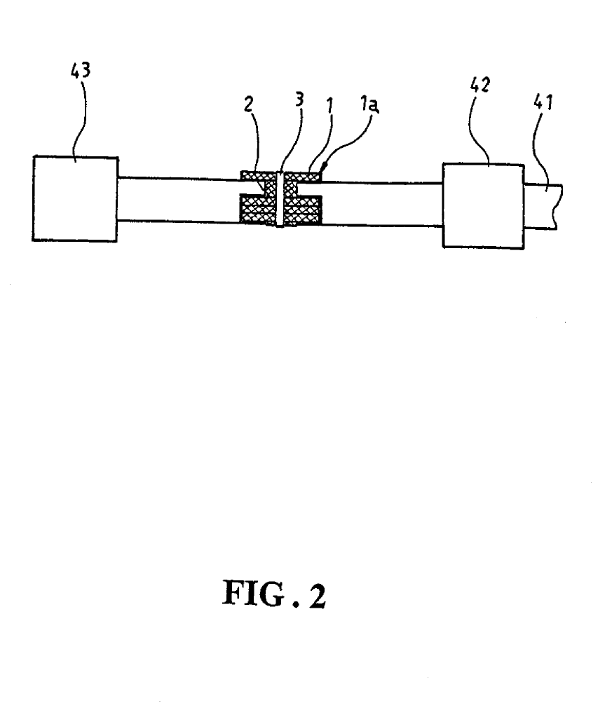

FIG. 3 is a schematic view of the fuel-saving device mounted at the air purifier in accordance with the present invention.

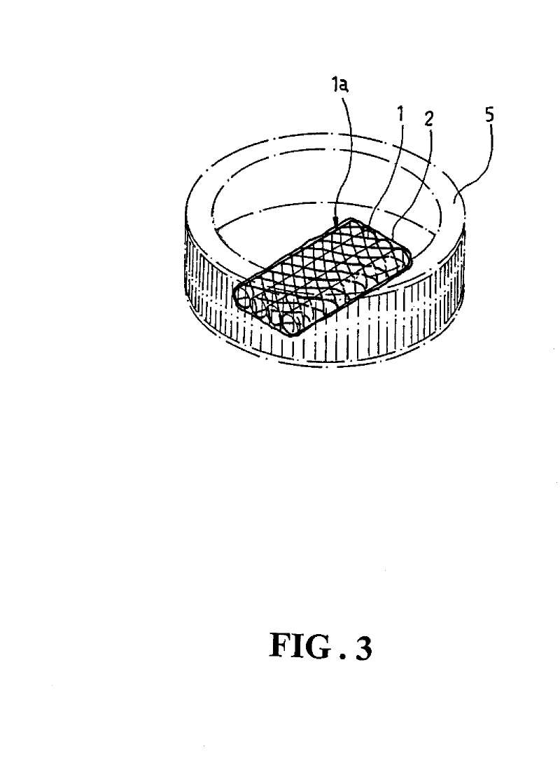

FIG. 4 is a preferred embodiment showing radiation of oxygen particles of a radiating member in accordance with the present invention.

FIG. 5 is a schematic view showing energy releasing of a radiating unit of the present invention.

FIG. 6 is another preferred embodiment in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

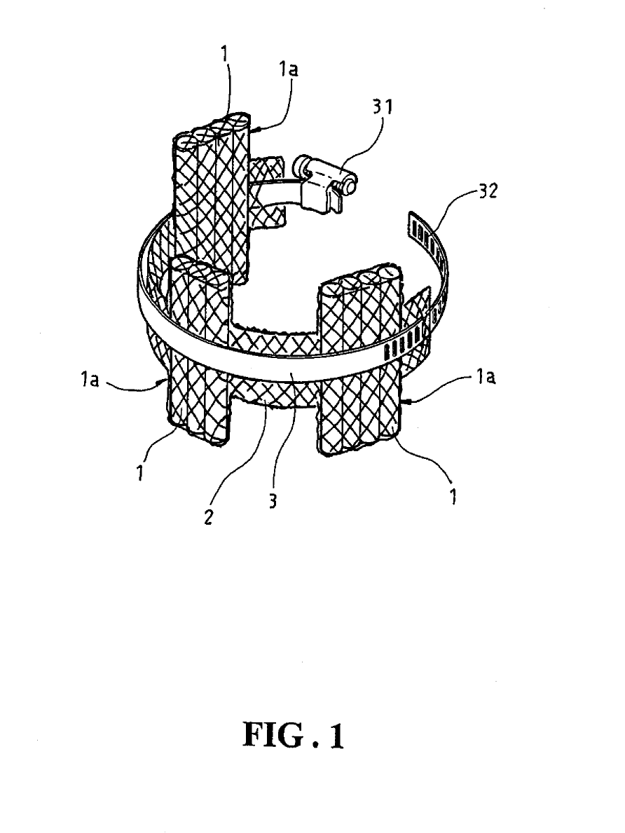

As shown in FIG. 1, there is shown a fuel-saving device comprising a plurality of radiating members 1 and a net member 2 connecting the radiating members 1. The radiating members 1 is a ceramic product produced from energy proton of extracted mineral crystalline elements together with corresponding energy element. The ceramic products are formed using best ratio of these elements, such that the radiating member units 1 are formed and aligned and each of the radiating member unit 1a is spaced-apart and the net member 2 hold each of the radiating member unit 1a.

The net member 2 is made from aluminum material, and each radiating member unit 1a is spaced and arranged. In a preferred embodiment, the radiating members 1 are arranged in four, three, four arrangement. The radiating member units 1a are tied and a fastening belt 3 passes through the net member 2, and the two ends of the fastening belt 3 are mounted respectively with a locking member 31 and a plurality of positioning holes for locking with the locking member 31.

In addition, exhaust gas pollution to the environment is lesser. Further, when in application, the fuel-saving device is mounted between the front end of the catalyst sensor 42, of the exhaust pipe 4 and the cylinder 43, and the positioning holes 32 end is locked to the locking member 31. The net 32 end of the radiating member unit 1a is mounted with the locking member 31 for fastening. The net member 2 is made from aluminum material so as to provide heat conduction effect such that the energy element of the radiating member 1 can be evenly discharged such that the air stream molecules between the base of the vehicle and the ground form into turbo energy, thus, a propel force is produced and a fuel-saving effect is obtained while the vehicle is driven.

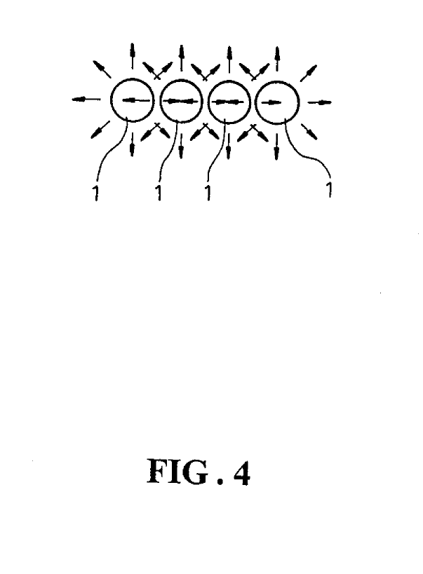

As shown in FIG. 4, a plurality of radiating members 1 are arranged and are in alignment. The energy element of the radiating member 1 converts the oxygen ions into ultra fine particles and are arranged in rows and in alignment such that the radiating oxygen particles collide with each other such that air stream molecules naturally generate turbo energy so as to form micro explosion for oxygen particles.

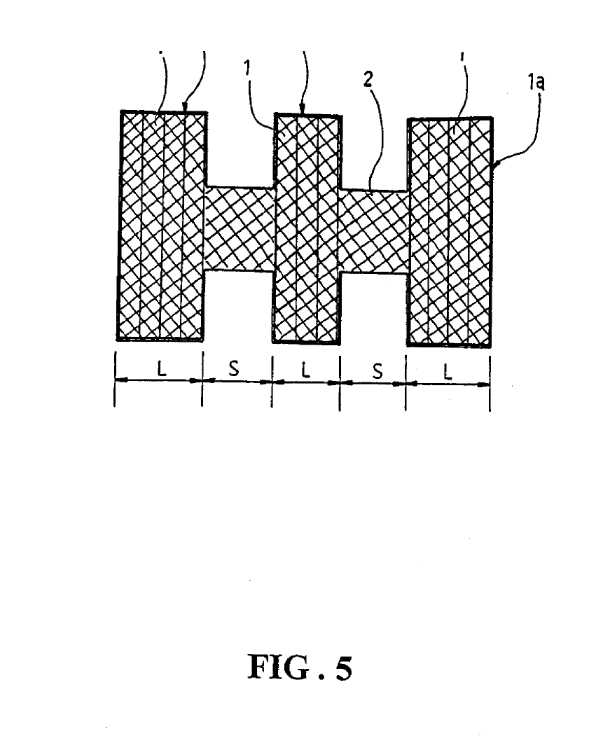

As shown in FIG. 5, each of the radiating members unit 1a are arranged in spaced apart. In a preferred embodiment, the number of the radiating members are arranged in four-three-four arrangement. The radiating members units 1a are tied and formed into partition zone for each radiating member unit 1a. Thus a strong (L), a weak (S) energy discharging is formed, and therefore, the production of turbo energy is increased and the micro explosion effect of the oxygen particles is enhanced.

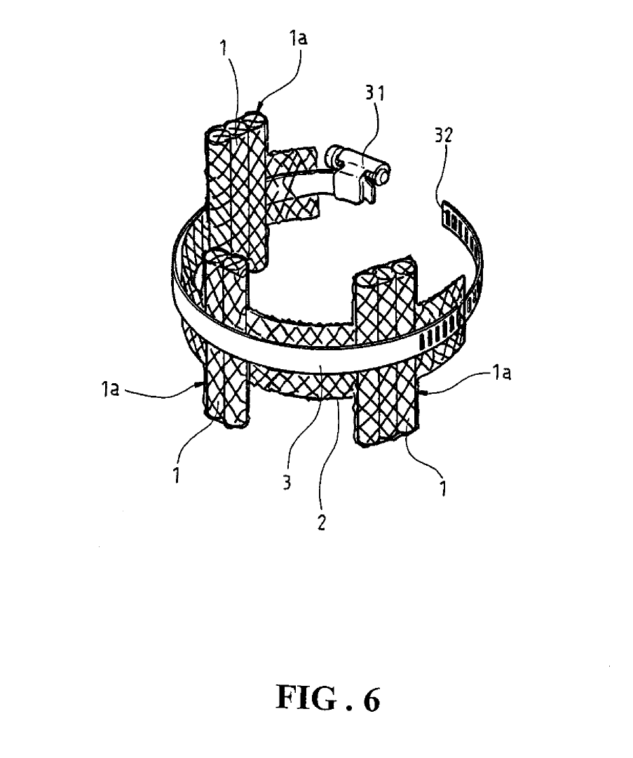

As shown in FIG. 6, the partitioned rows of the radiating member unit 1a can be in an arrangement of 3-2-3 or 5-4-5.

In view of the above, the partitioned rows of the radiating member units together with the net member connecting the radiating member units form into a fuel-saving device and the exhaust gas discharged from a vehicle to the surrounding is reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fuel-saving device comprising
a radiating members unit having a plurality of radiating members arranged in spaced-apart and arranged in an alignment;
net body for mounting to each of the spaced-apart radiating members,
wherein the fuel-saving device is disposed onto the front end of a catalyst sensor of the exhaust pipe of a vehicle, energy elements of the radiating members convert the oxygen ions to ultra micro particles and the collision of the oxygen particles causes the gas stream molecules to generate naturally turbo which produce propel action and a micro explosion of oxygen particles, the oxygen particles enter the cylinder of the vehicle enhance complete combustion of gasoline.

2. The fuel-saving device of claim 1, wherein the radiating members are ceramic product obtained based on a specific ratio from energy proton of extracted crystal element corresponding to energy element.

3. The fuel-saving device of claim 1, wherein the net body connecting the radiating member units is made from aluminum material to provide heat conduction effect such that the energy element of the radiating members is evenly distributed.

4. The fuel-saving device of claim 1, wherein the net body is mounted with a fastening belt, and the two ends of the fastening belt are respectively provided with a locking element and a plurality of positioning holes for the fastening belt wherein the locking element locks the radiating member unit to the front end of the catalyst sensor
